(19) United States
(12) Patent Application Publication
(10) Pub. No.: US 2011/0134070 A1
(43) Pub. Date: Jun. 9, 2011

(54) CAPACITIVE TOUCH PANEL

(75) Inventors: Wei-Wen Wang, Taoyuan County (TW); Ting-Chieh Chen, Taoyuan County (TW); Teo Boon Hock, Taoyuan County (TW); Sheng-Hsien Lin, Taoyuan County (TW); Yuh-Rur Kuo, Taoyuan County (TW); Shih-Hsien Ma, Taoyuan County (TW)

(73) Assignee: Transtouch Technology Inc., Taoyuan County (TW)

(21) Appl. No.: 12/759,071

(22) Filed: Apr. 13, 2010

(30) Foreign Application Priority Data
Dec. 3, 2009 (TW) 098222637

(51) Int. Cl. G06F 3/045; H01J 9/00

(52) U.S. Cl. 345/174; 445/24

(57) ABSTRACT

A capacitive touch panel including a transparent substrate, a plurality of first metal wires, an insulation layer, a plurality of first sensing units, a plurality of second sensing units and a plurality of second metal wires are provided. The transparent substrate has a substrate surface on which the first metal wires, the first sensing units and the second sensing units are formed. The insulation layer can cover a portion of each first metal wire, which is connected to two of the first sensing units, wherein each second metal wire is connected to two of the second sensing units.

This application claims the benefit of Taiwan application Serial No. 98222637, filed Dec. 3, 2009, the subject matter of which is incorporated herein by reference.

### BACKGROUND OF THE INVENTION

1. Field of the Invention

The invention relates in general to a capacitive touch panel, and more particularly to a capacitive touch panel which electrically connects a sensing unit by a metal wire.

2. Description of the Related Art

Referring to FIG. 1 (Prior Art), a schematic view of a generally known capacitive touch panel is shown. The capacitive touch panel 10 includes a substrate 12, a plurality of X-axial sensing units 14, a plurality of Y-axial sensing units 16 and an insulation layer 18.

The X-axial sensing units 14 are formed on the substrate 12. The insulation layer 18 covers the X-axial sensing units 14 and separates the X-axial sensing units 14 from the Y-axial sensing units 16.

The X-axial sensing units 14 are connected via indium tin oxide (ITO), and so are the, Y-axial sensing units 16 connected via ITO.

The generally known X-axial sensing units 14 and Y-axial sensing unit 16 are formed on two different planes, and the X-axial sensing units 14 and the Y-axial sensing unit 16 are separated by the insulation layer 18, so the light passing through has poor transmittance. Thus, the capacitive touch panel 10 has color cast problem.

Besides, adjacent Y-axial sensing units 16 are interspaced by a distance D1, so that the Y-axial sensing units 16 are evident on the appearance of the capacitive touch panel 10. For example, if the Y-axial sensing units 16 are yellow, then yellow traces can be seen on the appearance, not only jeopardizing the aesthetics but also deteriorating the display quality of the capacitive touch panel 10.

### SUMMARY OF THE INVENTION

The invention is directed to a capacitive touch panel whose sensing units are disposed on the same plane, so that the gaps between the sensing units are reduced, not only increasing color uniformity on the panel surface of the capacitive touch panel but also improving the display quality of the capacitive touch panel.

According to a first aspect of the present invention, a capacitive touch panel is provided. The capacitive touch panel includes a transparent substrate, a plurality of first metal wires, an insulation layer, a plurality of first sensing units, a plurality of second sensing units and a plurality of second metal wires. The transparent substrate has a substrate surface on which the first metal wires, the first sensing units and the second sensing units are formed. The insulation layer can cover a portion of each first metal wire, which is connected to two of the first sensing units, wherein each second metal wire is connected to two of the second sensing units.

According to a second aspect of the present invention, a method manufacturing of a capacitive touch panel is provided. The manufacturing method includes the following steps. A transparent substrate having a substrate surface is provided. A plurality of first metal wires is formed on the substrate surface. An insulation layer covering a portion of each first metal wire is formed. A plurality of first sensing units is formed on the substrate surface, wherein adjacent two of the first sensing units are electrically connected to one of the first metal wires. A plurality of second sensing units is formed on the substrate surface. A plurality of second metal wires is formed on the insulation layer, wherein each second metal wire electrically connects adjacent two of the second sensing units.

According to a third aspect of the present invention, a method manufacturing of a capacitive touch panel is provided. The manufacturing method includes the following steps. A transparent substrate having a substrate surface is provided. A plurality of first sub-metal wires is formed on the substrate surface. A plurality of third sub-metal wires is formed on the substrate surface. An insulation layer covering a portion of each first sub-metal wire and a portion of each third sub-metal wire is formed. A plurality of first sensing units is formed on the substrate surface, wherein one of the first sub-metal wires electrically connects adjacent two of the first sensing units. A plurality of second sensing units is formed on the substrate surfaces, wherein one of the third sub-metal wires electrically connects adjacent two of the second sensing units. A plurality of second sub-metal wires is formed on the insulation layer, wherein each second sub-metal wire electrically connects adjacent two of the first sensing units. A plurality of fourth sub-metal wires is formed on the insulation layer, wherein each fourth sub-metal wire electrically connects adjacent two of the second sensing units.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a schematic view of a generally known capacitive touch panel;

FIG. 2 shows a top view of a capacitive touch panel according to the first embodiment of the invention;

FIG. 3 shows a cross-sectional view along the direction 3-3′of FIG. 2;

FIG. 4 shows a cross-sectional view along the direction 4-4′ of FIG. 2;

FIG. 5 shows a cross-sectional view along the direction 5-5′ of FIG. 2;

FIG. 6 shows a manufacturing process of a capacitive touch panel according to the first embodiment of the invention;

FIG. 7A to 7C show a schematic view manufacturing of the capacitive touch panel of FIG. 1;

FIGS. 8 and FIG. 9 respectively show a cross-sectional view of a capacitive touch panel according to the second embodiment of the invention;

FIG. 10 shows a top view of a capacitive touch panel according to the third embodiment of the invention;

FIG. 11 shows a top view of a second sub-signal wire according to another embodiment of the invention;

FIG. 12 shows a top view of a second sub-signal wire according to yet another embodiment of the invention;

FIG. 13 shows a top view of a capacitive touch panel according to the fourth embodiment of the invention;

FIG. 14 shows a cross-sectional view along the direction 14-14′ of FIG. 13;

FIG. 15 shows a top view of a capacitive touch panel according to the fifth embodiment of the invention;

FIG. 16 shows a cross-sectional view along the direction 16-16′ of FIG. 15;

FIG. 17 shows a cross-sectional view along the direction 17-17′ of FIG. 15;

FIG. 18 shows a top view of a capacitive touch panel according to the sixth embodiment of the invention;

FIG. 19 shows a cross-sectional view along the direction 19-19′ of FIG. 18;

FIG. 20 shows a cross-sectional view along the direction 20-20′ of FIG. 18;

FIG. 21 shows a manufacturing process of a capacitive touch panel according to the sixth embodiment of the invention;

FIGS. 22A to 22D respectively show a schematic view manufacturing of the capacitive touch panel of FIG. 18; and

FIG. 23 shows a top view of a capacitive touch panel according to the seventh embodiment of the invention.

### DETAILED DESCRIPTION OF THE INVENTION

A number of preferred embodiments are disclosed below for elaborating the details of the invention. However, the invention is not limited to the embodiments, and the embodiments are for elaborating the invention not for limiting the scope of protection of the invention. Moreover, secondary elements are omitted in the embodiments to highlight the characteristics of the invention.

### First Embodiment

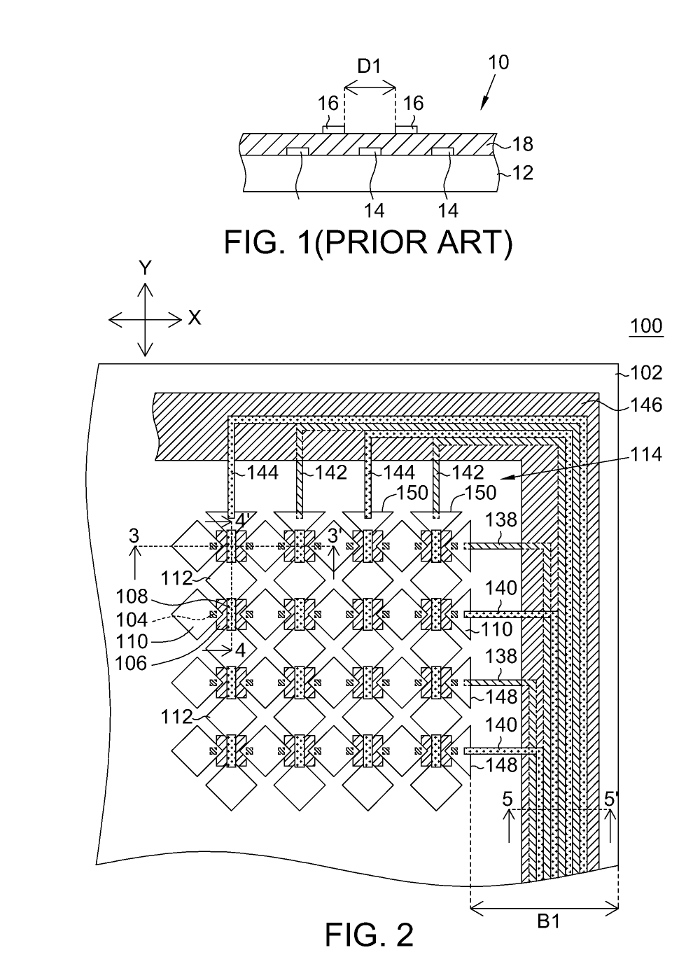

Referring to FIG. 2, a top view of a capacitive touch panel according to the first embodiment of the invention is shown. The capacitive touch panel 100 includes a transparent substrate 102, a plurality of first metal wires 104, an insulation layer 106, a plurality of second metal wires 108, a plurality of first sensing units 110 and a plurality of second sensing units 112. The transparent substrate 102 further has a substrate surface 114. The transparent substrate 102 can be formed by an insulating material with high transmittance such as glass, polycarbonate (PC), polythylene terephthalate (PET), polymethylmethacrylate (PMMA) and cyclic olefin copolymer.

The first sensing units 110 and the first metal wires 104 are arranged as a plurality of first sensing wires 148, wherein each first sensing wire 148 is arranged along a first direction such as the X-axial direction. The second sensing units 112 and the second metal wires 108 are arranged as a plurality of second sensing wires 150, wherein each second sensing wire 150 is arranged along a second direction such as the Y-axial direction.

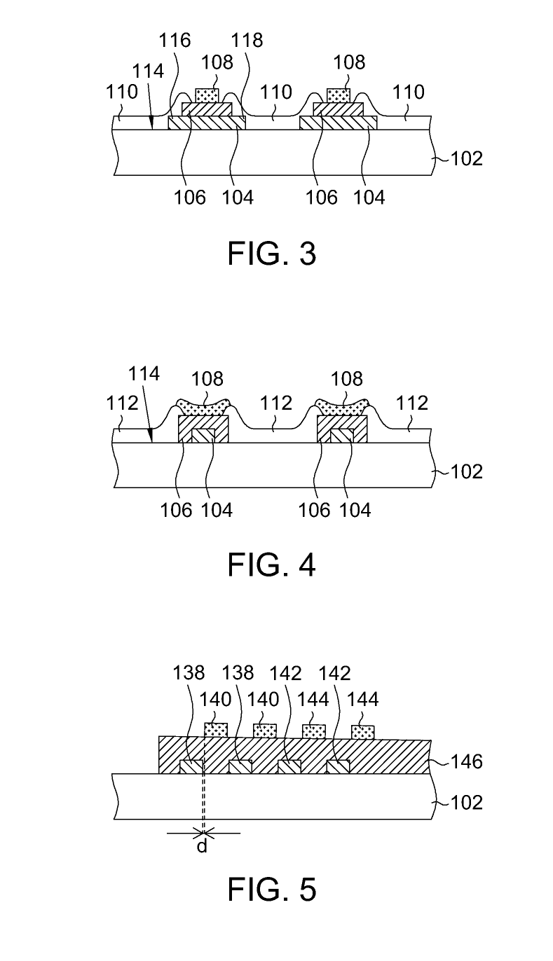

Referring to both FIG. 2 and FIG. 3. FIG. 3 shows a cross-sectional view along the direction 3-3′of FIG. 2. The first metal wires 104 and the first sensing units 110 are formed on the substrate surface 114.

The insulation layer 106 covers a portion of each first metal wires 104 but exposes a first end 116 and a second end 118 of the first metal wires 104, wherein the first end 116 and the second end 118 are opposite to each other and are electrically connected to adjacent two of the first sensing units 110, respectively. Since the first metal wires 104 are formed by metal which has lower impedance, the sensitivity of the capacitive touch panel 100 is further increased. The first metal wires 104 are formed by materials including such as at least one of molybdenum and aluminum.

Referring to both FIG. 2 and FIG. 4. FIG. 4 shows a cross-sectional view along the direction 4-4′ of FIG. 2. The insulation layer 106 and the second sensing units 112 are formed on the substrate surface 114. The second metal wires 108, crossing over the insulation layer 106, electrically connect adjacent two of the second sensing units 112.

Since the second metal wires 108 are formed by metals with lower impedance, the sensitivity of the capacitive touch panel 100 is increased. The material of the second metal wires 108 is similar to that of the first metal wires 104, and the similarities are not repeated here.

Since the metal has lower impedance, the width of the first metal wires 104 and that of the second metal wires 108 can be manufactured to be thinner, and the impedance still does not exceed the predetermined value. Besides, the parasitic capacitance between the first metal wires 104 and the second metal wires 108 is very small, so the sensitivity of the capacitive touch panel 100 is increased.

The first sensing units 110 and the second sensing units 112 adjacent thereto are formed on the same plane (that is, the substrate surface 114), so the gaps between the sensing units are reduced. Thus, the panel surface of the capacitive touch panel has better color uniformity and the display quality of the capacitive touch panel 100 can be improved.

Referring to FIG. 2, the capacitive touch panel 100 further includes a plurality of signal wires such as a plurality of first signal wires 138, a plurality of second signal wires 140, a plurality of third signal wires 142 and a plurality of fourth signal wires 144. The first signal wires 138 electrically connect a portion of the first sensing wires 148, and the second signal wires 140 correspondingly electrically connects the other portion of the first sensing wires 148, wherein the first signal wires 138 and the second signal wires 140 are interlaced. The third signal wires 142 correspondingly electrically connect a portion of the second sensing wires 150, and the fourth signal wires 144 correspondingly electrically connect the other portion of the second sensing wires 150, wherein the third signal wires 142 and the fourth signal wires 144 are interlaced.

Referring to both FIG. 2 and FIG. 5. FIG. 5 shows a cross-sectional view along the direction 5-5′ of FIG. 2. As indicated in FIG. 5, the first signal wires 138 and the third signal wires 142 are formed on the substrate surface 114 and extended to a periphery (as indicated in FIG. 2) of the substrate surface 114, wherein the periphery is such as outside the sensing region of the capacitive touch panel 100. A periphery portion 146 of the insulation layer 106 is formed on the periphery of the substrate surface 114 and covers the part of the first signal wires 138 and the third signal wires 142 extended to the periphery of the substrate surface 114. As indicated in FIG. 2, the second signal wires 140 and the fourth signal wires 144 are extended to the periphery portion 146 of the insulation layer 106. The signal wires formed on the periphery portion of the insulation layer 146 and the signal wires formed on the substrate surface 114 are interlaced. For example, the first signal wires 138 and the second signal wires 140 do not overlap and are alternated by a distance d along the extension direction of the substrate surface 114. Similarly, the third signal wires 142 and the fourth signal wires 144 do not overlap either and are alternated by a distance (not illustrated) and extended along the extension direction of the substrate surface 114.

Referring to FIG. 5. Since the signal wires, such as the first signal wires 138 and the second signal wires 140, can be formed on the surfaces having different heights, the distance d between the first signal wires 138 and the second signal wires 140 is smaller than the distance between conventional signal wires, the periphery width B1 (illustrated in FIG. 2) required by the transparent substrate 102 is smaller, and the capacitive touch panel 100 can be further down-sized.

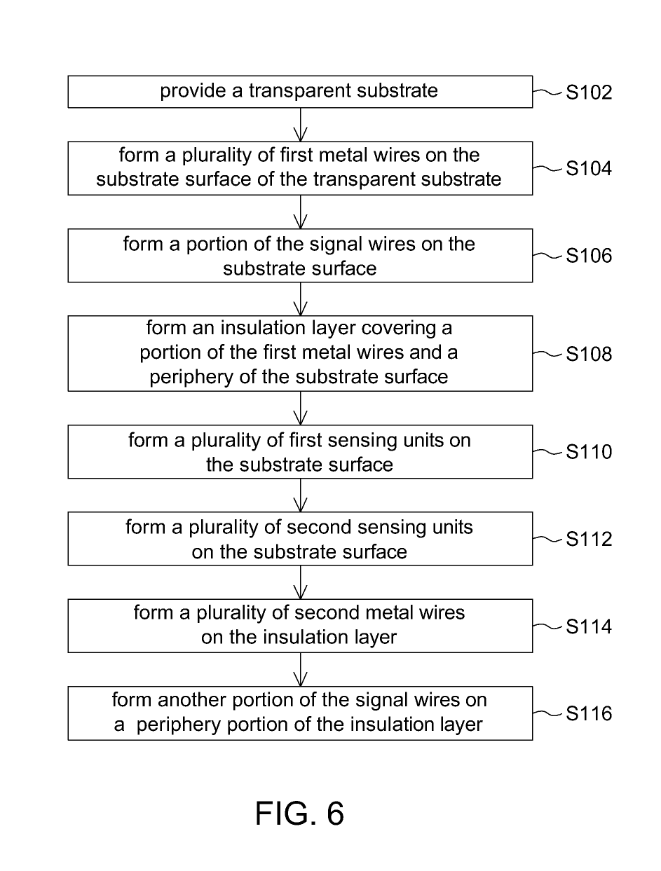

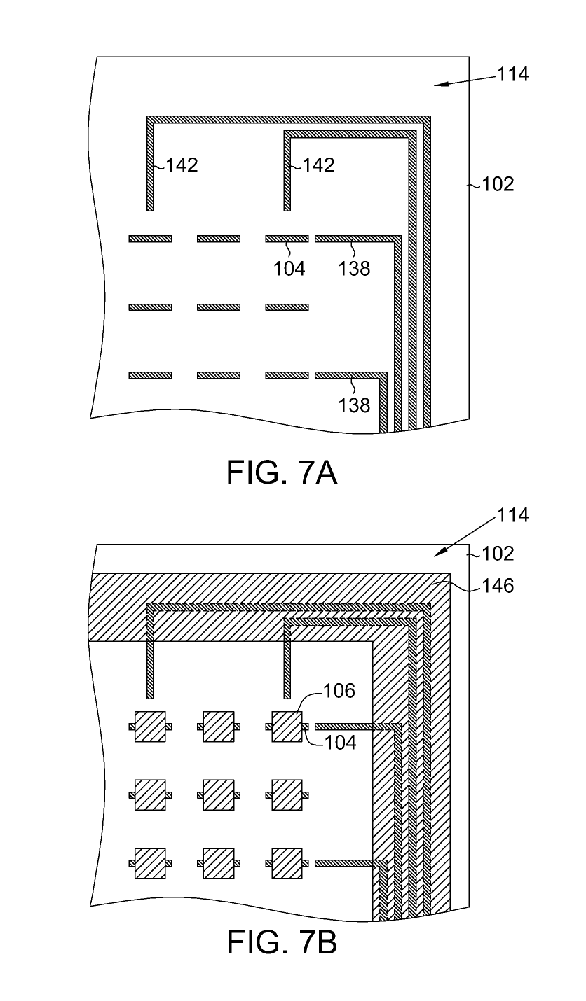

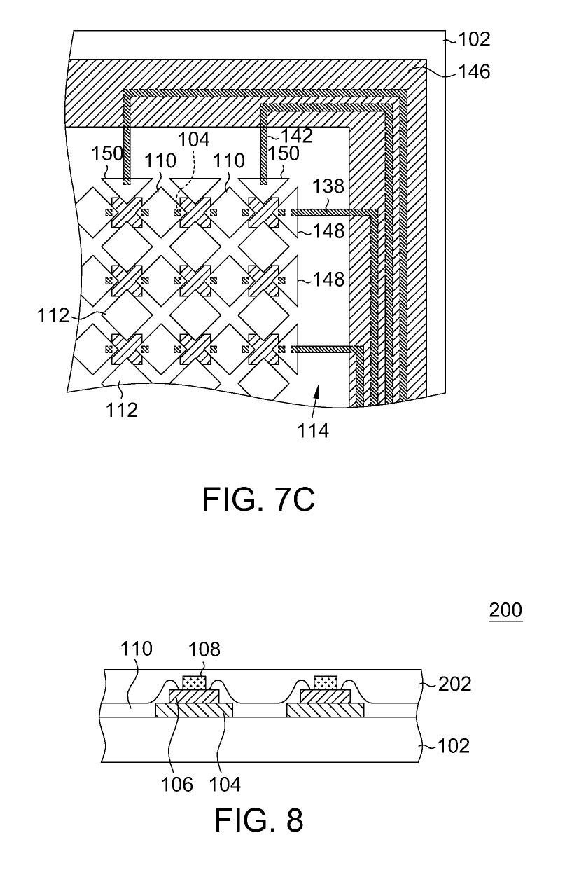

The manufacturing method of the capacitive touch panel 100 is disclosed below with the flowchart of FIG. 1. Referring to FIG. 6 and FIGS. 7A to 7C. FIG. 6 shows a manufacturing process of a capacitive touch panel according to the first embodiment of the invention. FIGS. 7A to 7C show a schematic view manufacturing of the capacitive touch panel of FIG. 1.

Firstly, the method begins at step S102, the transparent substrate 102 as indicated in FIG. 7A is provided.

Next, the method proceeds to step S104, the first metal wires 104 as indicated in FIG. 7A are formed on the substrate surface 114 of the transparent substrate 102 along a first direction.

Then, the method proceeds to step S106, a portion of the signal wires is formed on the substrate surface 114. For example, the first signal wires 138 and the third signal wires 142 as indicated in FIG. 7A are formed on the substrate surface 114, and the first signal wires 138 and the third signal wires 142 are extended to a periphery of the substrate surface 114.

The steps S104 to S106 can be formed by the same material in the same manufacturing process. According to the same manufacturing process, first of all, a metal material is formed by the coating technology, and then the first metal wires 104, the first signal wires 138 and the third signal wires 142 are formed by the patterning technology. Here, the coating technology refers to such as printing, spin coating or spraying, and the patterning technology refers to such as photolithography process, chemical etching, laser drilling, mechanical drilling or laser cutting.

Or, the first metal wires 104, the first signal wires 138 and the third signal wires 142 can be formed by chemical vapor deposition, electroless plating, electrolytic plating, printing, spin coating, spraying, sputtering or vacuum evaporation deposition.

Then, the method proceeds to step S108, as indicated in FIG. 7B, the insulation layer 106 covering a portion of each first metal wires 104 and a periphery of the substrate surface 114 is formed by the coating technology and the patterning technology. The periphery portion 146 of the insulation layer 106 covers the part of the first signal wires 138 and the third signal wires 142 extended to the periphery of the substrate surface 114.

Then, the method proceeds to step S110, as indicated in FIG. 7C, the first sensing units 110 are formed on the substrate surface 114 along a first direction (the X-axial direction), wherein adjacent two of the first sensing units 110 are electrically connected to one of the first metal wires 104. The first signal wires 138 are electrically connected to a portion of the first sensing wires 148. That is, not all of the first sensing wires 148 are electrically connected to the first signal wires 138.

Then, the method proceeds to step S112, as indicated in FIG. 7C, the second sensing units 112 are formed on the substrate surface 114 along a second direction (the Y-axial direction). The third signal wires 142 are electrically connected to a portion of the second sensing wires 150. That is, not all of the second sensing wires 150 are electrically connected to the third signal wire 142.

The steps S110 to S112 can be formed by the same material in the same manufacturing process. According to the same manufacturing process, first of all, a transparent conducting material is formed by the coating technology, and then the first sensing units 110 and the second sensing units 112 are formed by patterning a transparent conducting material by the patterning technology. Here, the transparent conducting material refers to materials such as transparent ITO or an organic conducting material such as polymer ethylenedioxy thiophene (PEDOT).

Here, the coating technology refers to the technologies such as printing, spin coating or spraying, and the patterning technology refers to such as photolithography process, chemical etching, laser drilling, mechanical drilling and laser cutting.

Or, in another implementation, the first sensing units 110 and the second sensing units 112 can be formed by chemical vapor deposition, electroless plating, electrolytic plating, printing, spin coating, spraying, sputtering or vacuum evaporation deposition.

Then, the method proceeds to step S114, the second metal wires 108 as indicated in FIG. 2 are formed on the insulation layer 106 along a second direction (the Y-axial direction), wherein each second metal wires 108 electrically connects adjacent two of the second sensing units 112.

Then, the method proceeds to step S116, the other portion of the signal wires as indicated in FIG. 2 is formed on the insulation layer 106. In greater details, the other portion of the second signal wires 140 electrically connected to the first sensing wires 148 is formed on the insulation layer 106, and the second signal wires 140 are extended to the periphery portion 146 of the insulation layer 106. Moreover, the other portion of the fourth signal wires 144 electrically connected to the second sensing wires 150 is formed, and the second signal wires 140 are extended to the periphery portion 146 of the insulation layer 106.

The steps S114 to S116 can be formed by the same material in the same manufacturing process in which the coating technology and the patterning technology are adapted.

### Second Embodiment

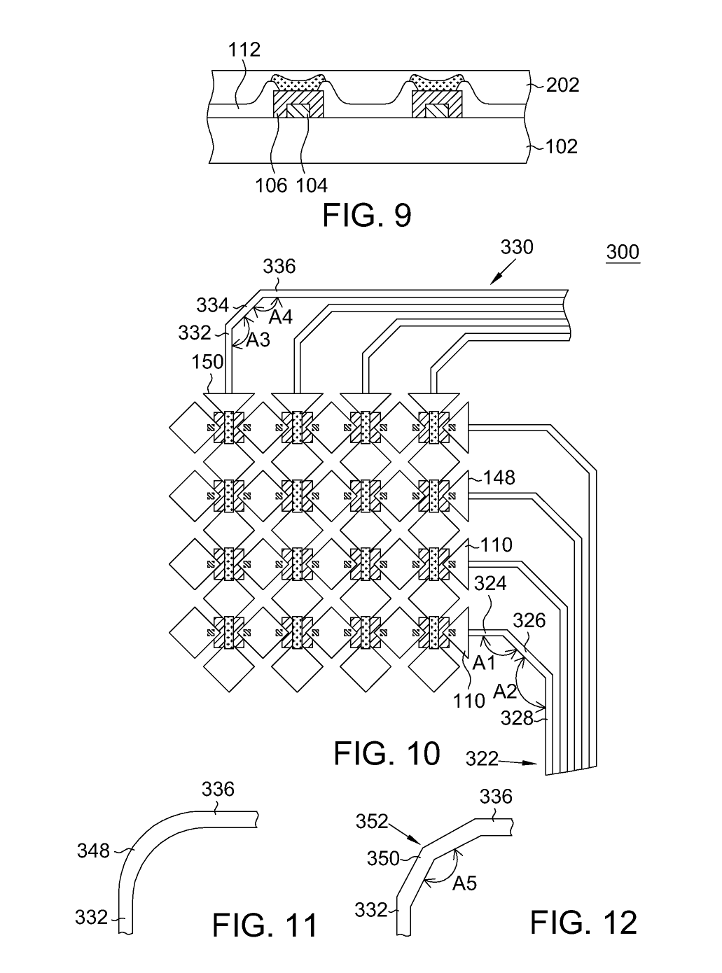

Referring to both FIG. 8 and FIG. 9, a cross-sectional view of a capacitive touch panel according to the second embodiment of the invention is respectively shown. As for the similarities between the second embodiment and the first embodiment, the same designations are used, and the similarities are not repeated here. The capacitive touch panel 200 of second embodiment is different from the capacitive touch panel 100 of the first embodiment in that, the capacitive touch panel 200 further includes an optical film 202.

The optical film 202 is formed on the substrate surface 114 and covers the first metal wires 104, the insulation layer 106, the first sensing units 110, the second sensing units 112 (not illustrated) and the second metal wires 108. The optical film 202 increases light transmittance. Preferably, the refractive index of the optical film 202 is smaller than 1.7. The optical film 202 can be formed by materials including silicon oxide, magnesium fluoride, aluminum oxide or yttrium oxide, and preferably, is formed by silicon oxide.

### Third Embodiment

Referring to FIG. 10, a top view of a capacitive touch panel according to the third embodiment of the invention is shown. As for the similarities between the third embodiment and the first embodiment, the same designations are used, and the similarities are not repeated here. The capacitive touch panel 300 of the third embodiment is different from the capacitive touch panel 100 of the first embodiment in that, the signal wires of the capacitive touch panel 300 have a bending shape.

In greater details, as indicated in FIG. 10, the capacitive touch panel 300 includes a plurality of signal wires, such as a plurality of first signal wires 322 and a plurality of second signal wires 330.

One end of the first signal wire 322 is electrically connected to the corresponding first sensing wire 148, and the other end of the first signal wire 322 is electrically connected to a signal output cable (not illustrated).

Each first signal wire 322 includes a first sub-signal wire 324, a second sub-signal wire 326 and a third sub-signal wire 328. The first sub-signal wire 324 is extended along the first direction, the third sub-signal wire 328 is extended along the second direction, and the second sub-signal wire 326 connects the first sub-signal wire 324 and the third sub-signal wire 328. A first obtuse angle A1 is contained between the second sub-signal wire 326 and the first sub-signal wire 324, and a second obtuse angle is contained between A2 the second sub-signal wire 326 and the third sub-signal wire 328. Preferably, the first obtuse angle A1 and the second obtuse angle A2 both range between 90 to 179 degrees.

The second sub-signal wires 326 form a bending shape of the first signal wires 322 for increasing the sensitivity.

Besides, one end of the second signal wires 330 is electrically connected to the corresponding second sensing wires 150, and the other end of the second signal wires 330 is electrically connected to the signal output cable.

Each second signal wire 330 includes a first sub-signal wire 332, a second sub-signal wire 334 and a third sub-signal wire 336. The first sub-signal wire 332 is extended along the second direction, the third sub-signal wire 336 is extended along the first direction, and the second sub-signal wire 334 connects the first sub-signal wire 332 and the third sub-signal wire 336. A first obtuse angle A3 is contained between the second sub-signal wire 334 and the first sub-signal wire 332, and a second obtuse angle is contained A4 between the second sub-signal wire 334 and the third sub-signal wire 336. Preferably, the first obtuse angle A3 and the second obtuse angle A4 both range between 90 to 179 degrees.

The second sub-signal wires 334 form a bending shape of the second signal wires 330 for increasing the sensitivity.

However, the signal wires of the invention are not restricted by the above exemplifications and can have other implementations. Referring to FIG. 11, a top view of a second sub-signal wire according to another embodiment of the invention is shown. In the another embodiment, the silhouette of the second sub-signal wire 348 can be an arc. Referring to FIG. 12, a top view of a second sub-signal wire according to yet another embodiment of the invention is shown. In the yet another embodiment, the second sub-signal wires 350 may have a bending portion 352, which forms a bending angle A5. Or, in other implementations, the second sub-signal wires 350 can have many bending portions, and forms many bending angles.

### Fourth Embodiment

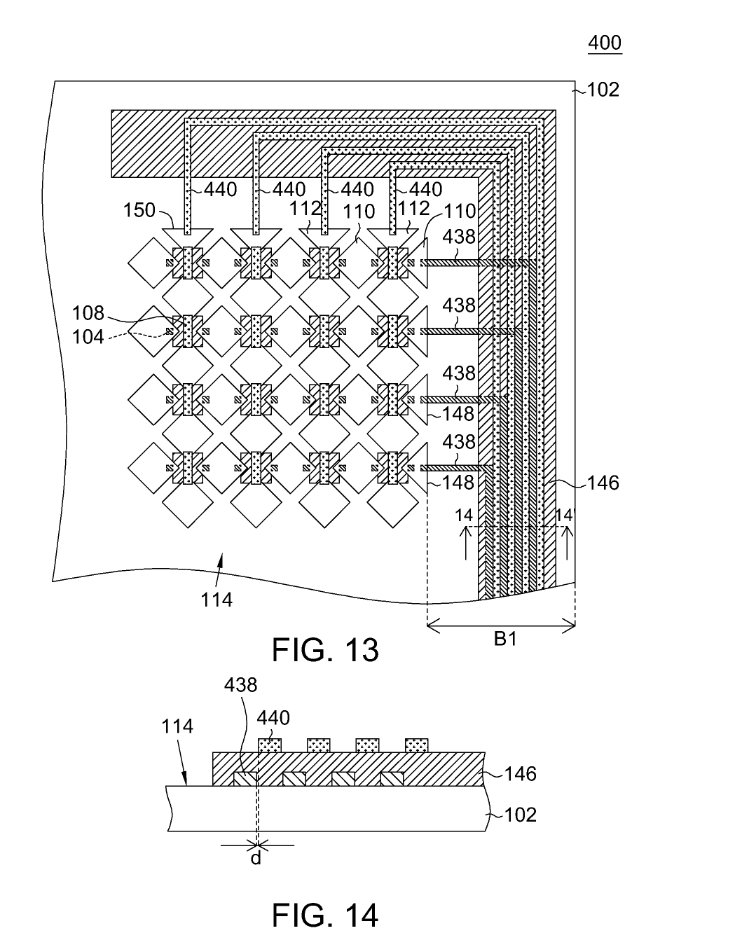

Referring to both FIG. 13 and FIG. 14. FIG. 13 shows a top view of a capacitive touch panel according to the fourth embodiment of the invention. FIG. 14 shows a cross-sectional view along the direction 14-14′ of FIG. 13. As for the similarities between the fourth embodiment and the first embodiment, the same designations are used, and the similarities are not repeated here. The capacitive touch panel 400 of the fourth embodiment is different from the capacitive touch panel 100 of the first embodiment in that, the signal wires, which electrically connect the capacitive touch panel 400 of the present embodiment of the invention and the first sensing wires 148, are all formed on the substrate surface 114, and the signal wires, which electrically connect the capacitive touch panel 400 of the present embodiment of the invention the second sensing wire 150, are all formed on the insulation layer 106.

In greater details, the capacitive touch panel 400 includes a plurality of signal wires such as a plurality of fifth signal wires 438 and a plurality of sixth signal wires 440. The fifth signal wires 438, formed on the substrate surface 114, are electrically connected to the first sensing wires 148 and are extended to the periphery of the substrate surface 114 covered by the periphery portion 146 of the insulation layer 106. The sixth signal wires 440 are formed on the insulation layer 106 and are electrically connected to the second sensing wire 150.

Since the fifth signal wires 438 and the sixth signal wires 440 can be formed on the surfaces having different heights (such as the substrate surface 114 and the top surface of the insulation layer 106), the periphery width B1 required by the transparent substrate 102 is reduced, and the capacitive touch panel 400 can be further down-sized

The manufacturing method of the capacitive touch panel 400 is disclosed below with the flowchart of FIG. 6. The fifth signal wires 438 can be formed in the step S106 of FIG. 6, and the sixth signal wires 440 can be formed in the step S116 of FIG. 6. Since the remaining steps are similar to the manufacturing method of the capacitive touch panel 100, and the similarities are not repeated here.

As indicated in the first embodiment and the fourth embodiment, the signal wires of the invention can be disposed according to many different implementations. For example, in other implementations, all of the signal wires of the capacitive touch panel can be formed on the substrate surface 114 or only a portion of the signal wires are formed on the periphery portion 146 of the insulation layer 106. Or, a portion of the signal wires can be formed on the substrate surface 114, and the other portion of the signal wires can be formed on the insulation layer as indicated in FIG. 2 and FIG. 13.

### Fifth Embodiment

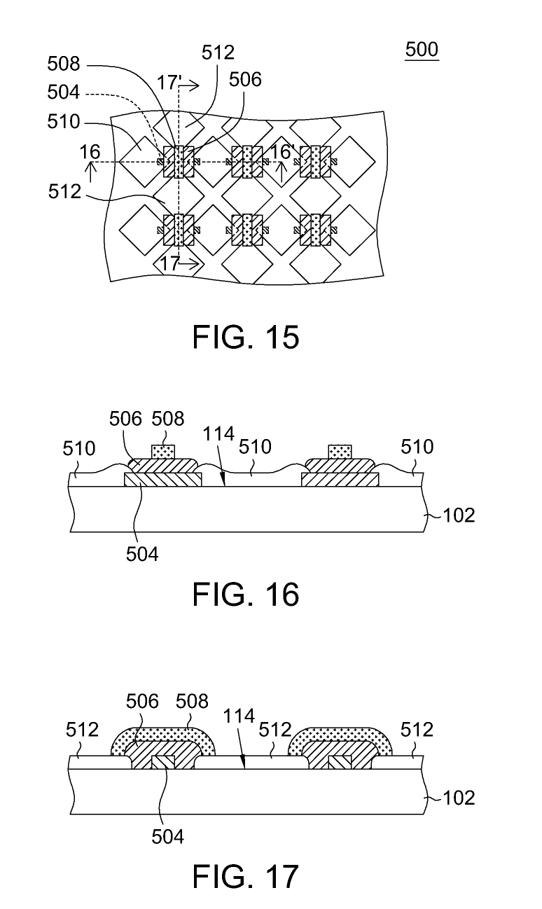

Referring to FIG. 15, FIG. 16 and FIG. 17. FIG. 15 shows a top view of a capacitive touch panel according to the fifth embodiment of the invention. FIG. 16 shows a cross-sectional view along the direction 16-16′ of FIG. 15. FIG. 17 shows a cross-sectional view along the direction 17-17′ of FIG. 15. As for the similarities between the fifth embodiment and the first embodiment, the same designations are used, and the similarities are not repeated here. The capacitive touch panel 500 of the fifth embodiment is different from the capacitive touch panel 100 of the first embodiment in that, the insulation layer 506 of the present embodiment of the invention covers both a portion of the first sensing units 510 and a portion of the second sensing units 512.

As indicated in FIG. 15, the capacitive touch panel 500 includes a transparent substrate 102, a plurality of first metal wires 504, an insulation layer 506, a plurality of second metal wires 508, a plurality of first sensing units 510 and a plurality of second sensing units 512.

As indicated in FIG. 16, the first metal wires 504 and the first sensing units 510 are both formed on the substrate surface 114. The insulation layer 506 covers a portion of the first metal wires 504. The two ends of first metal wires 504 are electrically connected to adjacent two of the first sensing units 510 respectively.

In the present embodiment of the invention, the insulation layer 506 covers both a portion of the first sensing units 510 and a portion of the second sensing units 512 (as indicated in FIG. 15). However, in other implementations, the insulation layer 506 can only cover the first metal wires 504 but not the first sensing units 510 or the second sensing units 512 as long as the first metal wires 504 and the second metal wires 508 can be separated during the formation of the insulation layer 506.

As indicated in FIG. 17, the insulation layer 506 and the second sensing unit 512 are formed on the substrate surface 114. The second metal wires 508, crossing over the insulation layer 506, electrically connect adjacent two of the second sensing units 512.

Besides, the first metal wires 504 and the second metal wires 508 are formed by materials similar to that of the first metal wires 104 and the second metal wires 108 of the first embodiment, and the similarities are not repeated here.

The manufacturing method of the capacitive touch panel 500 is disclosed below with the flowchart of FIG. 6. The step S108 of forming the insulation layer 506 can be completed between step S112 and S114. The remaining steps are similar to the manufacturing method of the capacitive touch panel 100, and the similarities are not repeated here.

The capacitive touch panel 500 of the present embodiment of the invention further includes the technical features of the signal wires which are disclosed in the first, the third and the fourth embodiment, and the similarities are not repeated here although the technical features are not illustrated.

### Sixth Embodiment

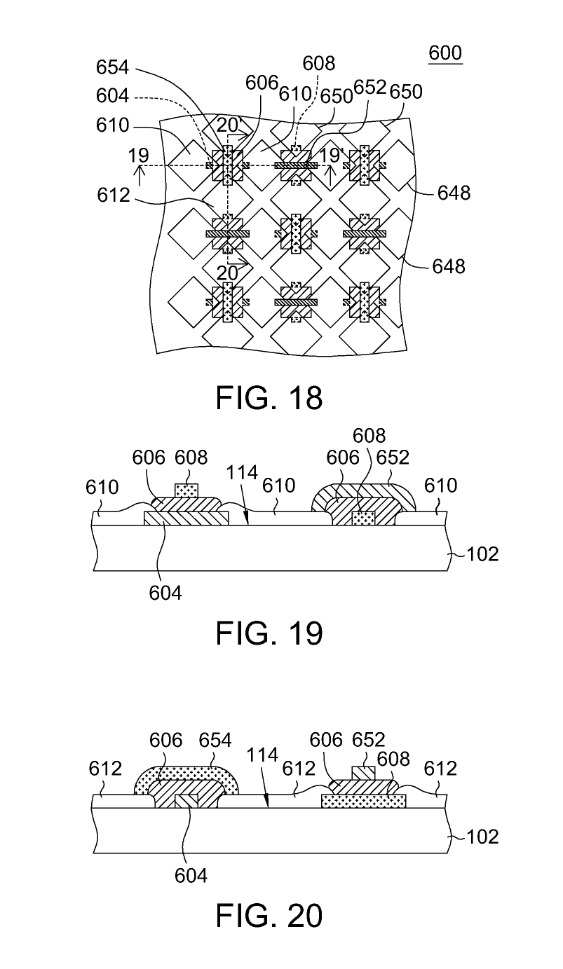

Referring to FIG. 18, FIG. 19 and FIG. 20. FIG. 18 shows a top view of a capacitive touch panel according to the sixth embodiment of the invention. FIG. 19 shows a cross-sectional view along the direction 19-19′ of FIG. 18. FIG. 20 shows a cross-sectional view along the direction 20-20′ of FIG. 18. As for the similarities between the sixth embodiment and the first embodiment, the same designations are used, and the similarities are not repeated here. The capacitive touch panel 600 of the sixth embodiment is different from the capacitive touch panel 100 of the first embodiment in that, in the present embodiment of the invention, a portion of a plurality of first metal wires is formed on the substrate surface 114, the other portion of the first metal wires is formed on the insulation layer 606, a portion of a plurality of second metal wires is formed on the substrate surface 114, and the other portion of the second metal wires is formed on the insulation layer 606.

As indicated in FIG. 18, the capacitive touch panel 600 includes a transparent substrate 102, a plurality of first metal wires, an insulation layer 606, a plurality of second metal wires, a plurality of first sensing units 610 and a plurality of second sensing units 612. The first metal wires (that is, the first sub-metal wires 604 and the second sub-metal wires 652) and the first sensing units 610 are arranged as a plurality of first sensing wires 648, and the second metal wires (that is, the third sub-metal wires 608 and the fourth sub-metal wires 654) and the second sensing units 612 are arranged as a plurality of second sensing wires 650.

As indicated in FIG. 18, FIG. 19 and FIG. 20, the first metal wires includes a plurality of first sub-metal wires 604 and a plurality of second sub-metal wires 652. The first sub-metal wires 604 are formed on the substrate surface 114 (substrate surface 114 is illustrated in FIG. 19). The insulation layer 606 covers a portion of each first sub-metal wire 604. The second sub-metal wires 652 are formed on the insulation layer 606. One of the first sub-metal wires 604 electrically connects a first one and a second one of the first sensing units 610. One of the second sub-metal wires 652 electrically connects the second and a third one of the first sensing units 610. That is, the first sub-metal wires 604 and the second sub-metal wires 652 adjacent thereto electrically connect three adjacent first sensing units 610 as indicated in FIG. 19.

Referring to FIG. 18, FIG. 19 and FIG. 20. The second metal wires includes a plurality of third sub-metal wires 608 and a plurality of fourth sub-metal wires 654. The third sub-metal wires 608 are formed on the substrate surface 114. The insulation layer 606 covers a portion of each third sub-metal wire 608. The fourth sub-metal wires 654 are formed on the insulation layer 606. One of the third sub-metal wires 608 electrically connects a first one and a second one of the second sensing units 612. One of the fourth sub-metal wires 654 electrically connects the second and a third one of the second sensing units 612. That is, the third sub-metal wires 608 and the fourth sub-metal wires 654 adjacent thereto electrically connect three adjacent second sensing units 612 as indicated in FIG. 20.

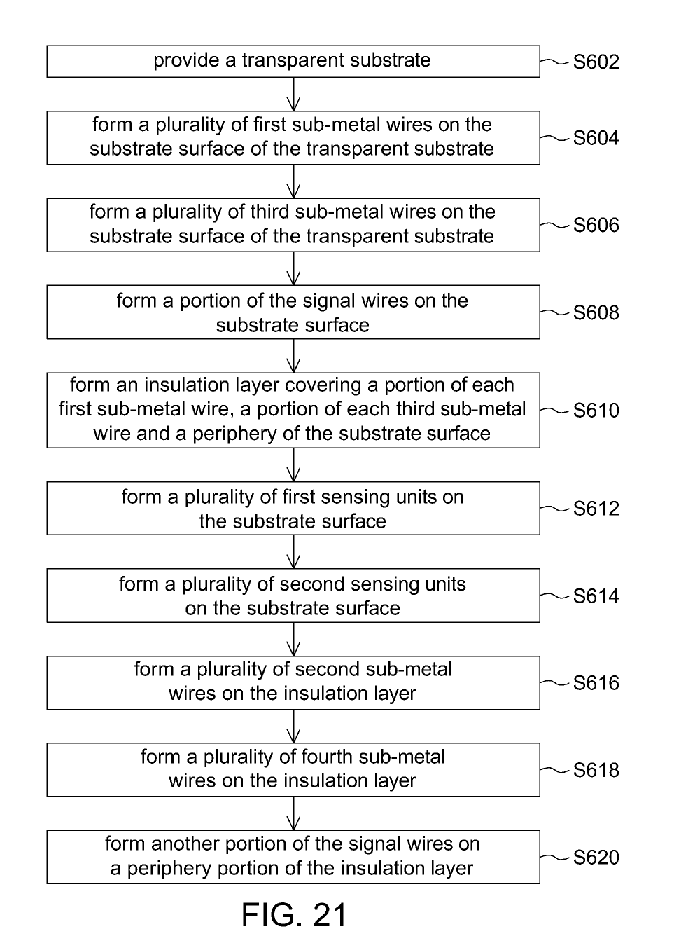

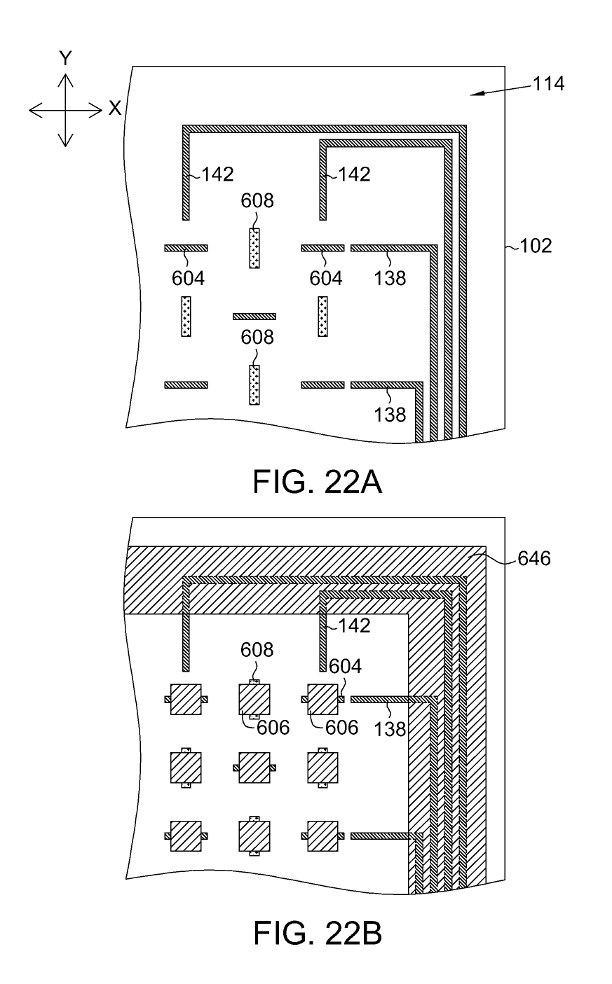

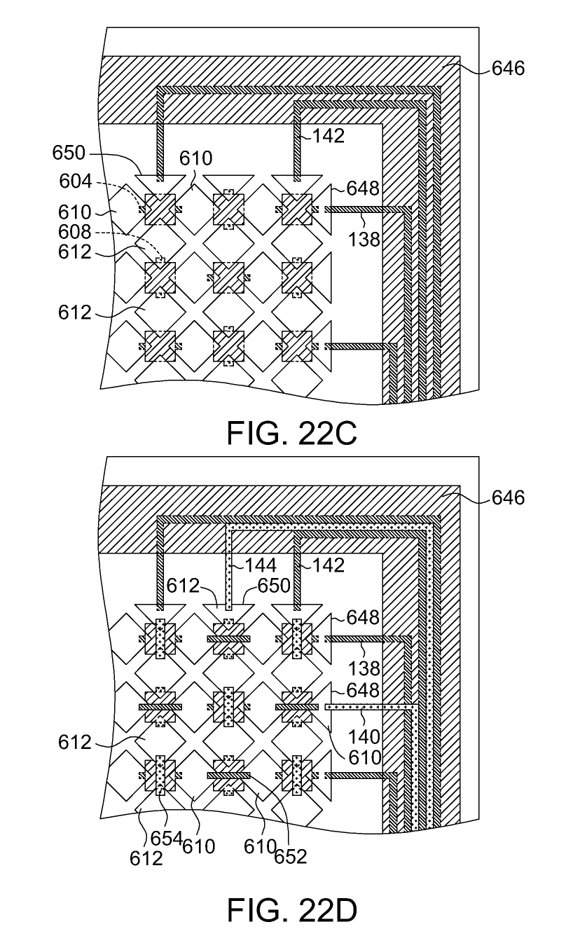

The manufacturing method of the capacitive touch panel 600 is disclosed below. Referring to FIG. 21 and FIGS. 22A to 22D. FIG. 21 shows a manufacturing process of a capacitive touch panel according to the sixth embodiment of the invention. FIGS. 22A to 22D respectively show a schematic view manufacturing of the capacitive touch panel of FIG. 18.

Firstly, the method begins at step S602, the transparent substrate 102 as indicated in FIG. 22A is provided.

Next, the method proceeds to step S604, the first sub-metal wires 604 as indicated in FIG. 22A are formed on the substrate surface 114 of the transparent substrate 102 along a first direction (the X-axial direction).

Then, the method proceeds to step S606, the third sub-metal wires 608 as indicated in FIG. 22A are formed on the substrate surface 114 of the transparent substrate 102 along a second direction (the Y-axial direction).

Then, the method proceeds to step S608, a portion of the signal wires is formed on the substrate surface 114. For example, the first signal wires 138 and the third signal wires 142 as indicated in FIG. 22A are formed on the substrate surface 114 and extended to a periphery of the substrate surface 114.

The above steps S604 to S608 can be formed by the same material in the same manufacturing process in which the coating technology and the patterning technology are adapted.

Then, the method proceeds to step S610, as indicated in FIG. 22B, the insulation layer 606 covering a portion of each first sub-metal wire 604 and a portion of each third sub-metal wire 608 is formed by the coating technology and the patterning technology. Wherein, the periphery portion 646 of the insulation layer 606 covers the part of the first signal wires 138 and the third signal wires 142 that is extended to a periphery of the substrate surface 114.

Then, the method proceeds to step S612, as indicated in FIG. 22C, the first sensing units 610 are formed on the substrate surface 114 along a first direction, wherein, one of the first sub-metal wires 604 electrically connects adjacent two of the first sensing units 110. The first signal wires 138 are connected to a portion of the first sensing wires 648. That is, not all of the first sensing wires 648 are connected to the first signal wires 138.

Then, the method proceeds to step S614, as indicated in FIG. 22C, the second sensing units 612 are formed on the substrate surface 114 along a second direction, wherein, one of the third sub-metal wires 608 electrically connects adjacent two of the second sensing units 612. The third signal wires 142 are electrically connected to a portion of the second sensing wires 650. That is, not all of the second sensing wires 650 are connected to the third signal wire 142.

The above steps S612 to S614 can be formed by the same material in the same manufacturing process in which photolithography process or laser cutting is adapted.

Then, the method proceeds to step S616, the second sub-metal wires 652 as indicated in FIG. 22D are formed on the insulation layer 606 along a first direction, wherein each second sub-metal wire 652 electrically connects adjacent two of the first sensing units 610.

Then, the method proceeds to step S618, the fourth sub-metal wires 654 as indicated in FIG. 22D are formed on the insulation layer 606 along a second direction, wherein each fourth sub-metal wires 654 electrically connects adjacent two of the second sensing units 612.

Then, the method proceeds to step S620, as indicated in FIG. 22D, the other portion of the signal wires is formed on the periphery portion 646 of the insulation layer 606. For example, the second signal wires 140 and the fourth signal wires 144 are formed on the periphery portion 146 the insulation layer 606. The second signal wires 140 are connected to the other portion of the first sensing wires 648. The fourth signal wires 144 are connected to the other portion of the second sensing wires 150. Thus, each first sensing wire 648 is electrically connected to the first signal wires 138 or the second signal wires 140, and each second sensing wire 650 is electrically connected to the third signal wires 142 or the fourth signal wires 144.

The above steps S616 to S620 can be formed by the same material in the same manufacturing process in which the coating technology and the patterning technology are adapted.

In the present embodiment of the invention, the insulation layer 606 covers both a portion of covers the first sensing unit 610 and a portion of the second sensing units 612 (as indicated in FIG. 18). However, in other implementations, the insulation layer 606 can only covers the first metal wire and the second metal wire but not the first sensing units 610 or the second sensing units 612 as long as the first metal wires (that is, the first sub-metal wires 604 and the second sub-metal wires 652) and the second metal wires (that is, the third sub-metal wires 608 and the fourth sub-metal wires 654) can be separated during the formation of the insulation layer 606.

Besides, the first metal wire and the second metal wire of the present embodiment of the invention are formed by materials similar to that of the first metal wires 104 and the second metal wires 108 of the first embodiment, and the similarities are not repeated here.

The capacitive touch panel 600 of the present embodiment of the invention further includes the technical features of the signal wires which are disclosed in the second, the third, the fourth embodiment, and the similarities are not repeated here although the technical features are not illustrated.

### Seventh Embodiment

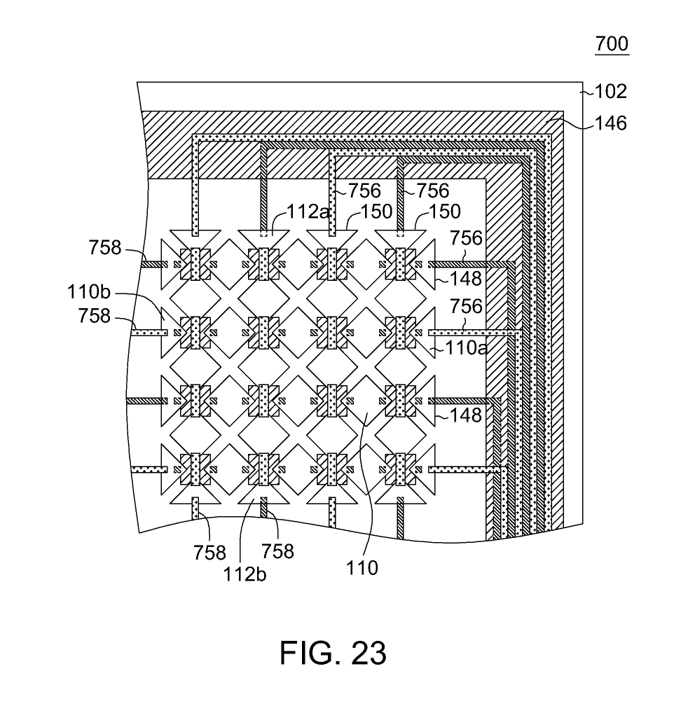

Referring to FIG. 23, a top view of a capacitive touch panel according to the seventh embodiment of the invention is shown. As for the similarities between the seventh embodiment and the first embodiment, the same designations are used, and the similarities are not repeated here. The capacitive touch panel 700 of the seventh embodiment is different from the capacitive touch panel 100 of the first embodiment n that, the two ends of the sensing wire of the capacitive touch panel 700 respectively connect two signal wires.

In greater details, the signal wires of the capacitive touch panel 700 include a plurality of seventh signal wires 756 and a plurality of eighth signal wires 758. The seventh signal wires 756 electrically connect the first sensing units 110a located at one end of the corresponding first sensing wires 148 or the second sensing units 112a located at one end of the corresponding second sensing wires 150. The eighth signal wires 758 electrically connect the first sensing units 110b located at the other end of the corresponding first sensing wires 148 or the second sensing units 112b located at the other end of the corresponding second sensing wires 150.

Besides, each seventh signal wire 756 and each eighth signal wire 758 are electrically connected to a signal output cable (not illustrated). Thus, when the sensing signal cannot be transmitted to the signal output cable through one of the seventh signal wire 756 and the eighth signal wire 758, the sensing signals still can be transmitted to the signal output cable through the other of the seventh signal wire 756 and the eighth signal wire 758. In greater details, let the first sensing wire 148 be taken for example. When the first metal wires 104 of the first sensing wires 148 that connect the first sensing units 110 are deprived of electrical connection (for example, the sensing wires are broken), making the sensing signals cannot be transmitted to the signal output cable through the seventh signal wire 756, the sensing signals still can be transmitted to the signal output cable through the eighth signal wire 758.

The capacitive touch panel disclosed in the above embodiments of the invention has many features exemplified below:

(1). The sensing units are disposed on the plane, so that the gaps between the sensing units are reduced, not only increasing color uniformity on the panel surface of the capacitive touch panel but also improving the display quality of the capacitive touch panel.

(2). The signal wires of the capacitive touch panel can have a bending shape for increasing the sensitivity.

(3). Since the signal wire can be formed on two surfaces having different heights, the periphery width required by the substrate is reduced, and the capacitive touch panel 400 can be further down-sized

(4). Since the first metal wires and the second metal wires can be formed by metal, which has lower impedance, the widths of the first metal wires and the second metal wires can be manufactured to be even thinner, and the impedance still does not exceed the predetermined value. In greater details, the parasitic capacitance between the first metal wires and the second metal wires is very small, so the sensitivity of the capacitive touch panel is increased.

(5). Since the sensing units located at two ends of each sensing wire can be respectively are electrically connected to two signal wires, the sensing signals still can be transmitted to the signal output cable through the other of the two signal wires when the sensing signals cannot be transmitted to the signal output cable through one of the two signal wires (for example, when the sensing wires are broken).

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A capacitive touch panel, comprising:
a transparent substrate having a substrate surface;
a plurality of first metal wires formed on the substrate surface;
an insulation layer covering a portion of the first metal wires;
a plurality of first sensing units formed on the substrate surface, wherein each first metal wire electrically connects two of the first sensing units;
a plurality of second sensing units formed on the substrate surface; and
a plurality of second metal wires, wherein each second metal wire electrically connects two of the second sensing units.

2. The capacitive touch panel according to claim 1, wherein the first metal wires and the first sensing units are arranged as a plurality of first sensing wires along a first direction, and the second metal wires and the second sensing units are arranged as a plurality of second sensing wires along a second direction.

3. The capacitive touch panel according to claim 1, wherein the first metal wires comprise a plurality of first sub-metal wires and a plurality of second sub-metal wires, the first sub-metal wires are formed on the substrate surface, the insulation layer covers a portion of each first sub-metal wire, the second sub-metal wires are formed on the insulation layer, one of the first sub-metal wires electrically connects a first one and a second one of the first sensing units, and one of the second sub-metal wires electrically connects the second one and a third one of the first sensing units.

4. The capacitive touch panel according to claim 3, the second metal wires comprise a plurality of third sub-metal wires and a plurality of fourth sub-metal wires, the third sub-metal wires are formed on the substrate surface, the insulation layer covers a portion of each third sub-metal wire, the fourth sub-metal wires are formed on the insulation layer, one of the third sub-metal wires electrically connects a first one and a second one of the second sensing units, and one of the fourth sub-metal wires electrically connects the second and a third one of the second sensing units.

5. The capacitive touch panel according to claim 2, further comprising:
a plurality of signal wires formed on the transparent substrate, wherein the signal wire are electrically connected to the first sensing wires and the second sensing wires;
wherein, each signal wire comprises a first sub-signal wire, a second sub-signal wire and a third sub-signal wire, a first obtuse angle is contained between the first sub-signal wire and the second sub-signal wire, and a second obtuse angle is contained between the second sub-signal wire and the third sub-signal wire;
wherein, the first obtuse angle ranges between 90 and 179 degrees, and the second obtuse angle ranges between 90 and 179 degrees.

6. The capacitive touch panel according to claim 5, wherein the second sub-signal wire is in the shape of an arc or has a bending portion.

7. The capacitive touch panel according to claim 2, further comprising:
a plurality of signal wires, wherein two of the signal wires respectively connect the first sensing units located at two ends of one of the first sensing wires, and another two of the signal wires respectively connect the second sensing units located at two ends of one of the second sensing wires.

8. The capacitive touch panel according to claim 2, wherein a periphery portion of the insulation layer is formed on a periphery of the substrate surface, and the capacitive touch panel further comprises:
a plurality of signal wires electrically connected to the first sensing wires and the second sensing wires, wherein a portion of the signal wires is formed on the substrate surface and extended to the periphery of the substrate surface, the periphery portion of the insulation layer covers the portion of the signal wires, and another portion of the signal wires is formed on the periphery portion of the insulation layer.

9. The capacitive touch panel according to claim 1, further comprising:
an optical film formed on the substrate and covering the first metal wires, the insulation layer, the first sensing units, the second sensing units and the second metal wires.

10. The capacitive touch panel according to claim 9, wherein the refractive index of the optical film is smaller than 1.7.

11. The capacitive touch panel according to claim 10, wherein the optical film is formed by material comprising silicon oxide, magnesium fluoride, aluminum oxide or yttrium oxide.

12. A method manufacturing of a capacitive touch panel, comprising:
providing a transparent substrate having a substrate surface;
forming a plurality of first metal wires on the substrate surface;
forming an insulation layer covering a portion of each first metal wire;
forming a plurality of first sensing units on the substrate surface, wherein adjacent two of the first sensing units are electrically connected to one of the first metal wires;
forming a plurality of second sensing units on the substrate surface; and
forming a plurality of second metal wires on the insulation layer, wherein each second metal wire electrically connects adjacent two of the second sensing units.

13. The manufacturing method according to claim 12, wherein the first metal wires and the first sensing units are arranged as a plurality of first sensing wires along a first direction, the second metal wires and the second sensing units are arranged as a plurality of second sensing wires along a second direction.

14. The manufacturing method according to claim 13, further comprising:
forming a plurality of signal wires on the transparent substrate, wherein the signal wire are electrically connected to the first sensing wires and the second sensing wires;
wherein, each signal wire comprises a first sub-signal wire, a second sub-signal wire and a third sub-signal wire, a first obtuse angle is contained between the first sub-signal wire and the second sub-signal wire, a second obtuse angle is contained between the second sub-signal wire and the third sub-signal wire, and the first obtuse angle and the second obtuse angle both range between 90 and 179 degrees.

15. The manufacturing method according to claim 14, wherein the second sub-signal wire is in the shape of an arc or has a bending portion.

16. The manufacturing method according to claim 13, further comprising:
forming a plurality of signal wires on the transparent substrate, wherein two of the signal wires respectively connect the first sensing units located at two ends of one of the first sensing wires, and another two of the signal wires respectively connect the second sensing units located at two ends of one of the second sensing wires.

17. The manufacturing method according to claim 13, wherein in the step of forming the insulation layer covers the first metal wires, a periphery portion of the insulation layer is formed on a periphery of the substrate surface, and the manufacturing method further comprises:
forming a plurality of signal wires on the transparent substrate, wherein the signal wire are electrically connected to the first sensing units and the second sensing units, a portion of the signal wires is formed on the substrate surface and extended to the periphery of the substrate surface, and the periphery portion of the insulation layer covers the portion of the signal wires, and another portion of the signal wires are formed on the periphery portion of the insulation layer.

18. A manufacturing method of a capacitive touch panel, comprising:
providing a transparent substrate having a substrate surface;
forming a plurality of first sub-metal wires on the substrate surface;
forming a plurality of third sub-metal wires on the substrate surface;
forming an insulation layer covers a portion of each first sub-metal wire and a portion of each third sub-metal wire;
forming a plurality of first sensing units the substrate surface, wherein one of the first sub-metal wires electrically connects adjacent two of the first sensing units;
forming a plurality of second sensing units on the substrate surface, wherein one of the third sub-metal wires electrically connects adjacent two of the second sensing units;
forming a plurality of second sub-metal wires on the insulation layer, wherein each second sub-metal wire electrically connects adjacent two of the first sensing units; and
forming a plurality of fourth sub-metal wires on the insulation layer, wherein each fourth sub-metal wire electrically connects adjacent two of the second sensing units.

19. The manufacturing method according to claim 18, wherein the first metal wires and the first sensing units are arranged as a plurality of first sensing wires along a first direction, and the second metal wires and the second sensing units are arranged as a plurality of second sensing wires along a second direction.

20. The manufacturing method according to claim 19, further comprising:
forming a plurality of signal wires on the transparent substrate, wherein the signal wire are electrically connected to the first sensing wires and the second sensing wires;
wherein, each signal wire comprises a first sub-signal wire, a second sub-signal wire and a third sub-signal wire, a first obtuse angle is contained between the first sub-signal wire and the second sub-signal wire, a second obtuse angle is contained between the second sub-signal wire and the third sub-signal wire, and the first obtuse angle and the second obtuse angle both range between 90 and 179 degrees.

21. The manufacturing method according to claim 20, wherein the second sub-signal wire is in the shape of an arc or has a bending portion.

22. The manufacturing method according to claim 19, further comprising:
forming a plurality of signal wires on the transparent substrate, wherein two of the signal wires respectively connect the first sensing units located at two ends of one of the first sensing wires, and another two of the signal wires respectively connect the second sensing units located at two ends of one of the second sensing wires.

23. The manufacturing method according to claim 19, wherein in the step of forming the insulation layer covering the first metal wires, a periphery portion of the insulation layer is formed on a periphery of the substrate surface, and the manufacturing method further comprises:
forming a plurality of signal wires on the transparent substrate, wherein the signal wire are electrically connected to the first sensing units and the second sensing units, a portion of the signal wires is formed on the substrate surface and extended to the periphery of the substrate surface, the periphery portion of the insulation layer covers the portion of the signal wires, and another portion of the signal wires is formed on the periphery portion of the insulation layer.
